(19) United States
(12) Patent Application Publication
(10) Pub. No.: US 2026/0093407 A1
(43) Pub. Date: Apr. 2, 2026

(54) MEMORY DEVICE AND METHOD OF OPERATING THE SAME

(71) Applicant: SK hynix Inc., Gyeonggi-do (KR)

(72) Inventor: Jong Wook KIM, Gyeonggi-do (KR)

(21) Appl. No.: 19/212,694

(22) Filed: May 20, 2025

(30) Foreign Application Priority Data
Sep. 27, 2024 (KR) 10-2024-0131932

(51) Int. Cl. G06F 3/06

(52) U.S. Cl. CPC G06F 3/064; G06F 3/0604; G06F 3/0655; G06F 3/0679

(57) ABSTRACT

A memory device may include a first memory block, a second memory block, a peripheral circuit, and a control circuit. The control circuit controls the peripheral circuit to program first data to the first memory block according to a single-level cell (SLC) scheme, generate second data by converting data read from the first memory block on a chunk basis, and program the second data to the second memory block according to a multi-level cell (MLC) scheme.

### CROSS-REFERENCE TO RELATED APPLICATION

The present application claims priority under 35 U.S.C. § 119(a) to Korean patent application number 10-2024-0131932, filed on Sep. 27, 2024, the entire disclosure of which is incorporated herein by reference.

### BACKGROUND

### 1. Technical Field

Various embodiments of the present disclosure relate to a memory device and a method of operating the memory device, and more particularly to a memory device for performing a migration operation and a method of operating the memory device.

### 2. Related Art

A memory device may include a memory cell array, a peripheral circuit, and a control circuit. The memory cell array may include a plurality of memory blocks, each of which may include memory cells connected between word lines and bit lines. The peripheral circuit may program, read or erase the memory cells under the control of the control circuit. The control circuit may control the peripheral circuit to perform a program operation, a read operation or an erase operation in response to a command.

Each memory cell may store at least 1 bit of data (e.g., in a floating gate of a cell transistor) according to the program scheme.

A program scheme for storing 1 bit of data in one memory cell is referred to as a single-level cell (SLC) scheme, and a program scheme for storing 2 or more bits of data in one memory cell is referred to as a multi-level cell (MLC) scheme. The single-level cell (SLC) scheme has relatively high program operation speed, but the capacity of data stored in the memory device is relatively small. The multi-level cell (MLC) scheme has relatively low program operation speed, but the capacity of data stored in the memory device is relatively large.

Some memory blocks included in the memory device may be set to be programmed according to the single-level cell (SLC) scheme, and other memory blocks may be set to be programmed according to the multi-level cell (MLC) scheme. That is, in order to improve the speed of the program operation, data input from an external system (e.g., a host) may be programmed to a memory block set in the single-level cell (SLC) scheme. Then, in order to increase the storage capacity of data, the memory device may copy back data in a memory block set in the single-level cell (SLC) scheme to a memory block set in the multi-level cell (MLC) scheme. In this way, an operation of copying back data in a memory block set to a low bit to a memory block set to a high bit may be referred to as a migration operation. For example, in performing the migration operation, data programmed to memory cells in the same column may be copied back to memory cells in another memory block.

During a read operation on a selected memory block, when error data is detected, the memory device may perform an error correction operation to convert error data into normal data. However, the error data may be converted into normal data only when the error data is detected within a range of a limited number of bits (an allowable number of fail bits). When the number of bits in the error data is greater than the allowable number of fail bits, the error data cannot be corrected, and thus the selected memory block may be treated as a bad block.

Since a migration operation is technology for compressing data stored in a plurality of memory cells (e.g., operating in an SLC scheme) and storing the data in a number of memory cells (e.g., operating in an MLC scheme) less than the plurality of memory cells operating in the SLC scheme, error data may be concentrated in a specific column of a memory block containing the memory cells operating in the MLC scheme. When the error data is concentrated in the specific column, the selected memory block may be treated as a bad block.

### SUMMARY

Various embodiments of the present disclosure are directed to a memory device and a method of operating the memory device, which can prevent error data from being concentrated in a specific column during a migration operation.

An embodiment of the present disclosure may provide for a memory device. The memory device may include a first memory block and a second memory block, a peripheral circuit coupled to the first memory block and the second memory block, and a control circuit configured to control the peripheral circuit to program first data to the first memory block according to a single-level cell (SLC) scheme, generate second data by converting data read from the first memory block on a chunk basis, and program the second data to the second memory block according to a multi-level cell (MLC) scheme, wherein each chunk corresponds to bits stored in a plurality of memory cells.

An embodiment of the present disclosure may provide for a memory device. The memory device may include a first memory block and a second memory block connected to bit lines, page buffers configured to change voltages of the bit lines based on original data during a program operation on the first memory block, and store read data, read from the first memory block, during a read operation on the first memory block, sub-buffers configured to receive the read data from the page buffers, generate shift data by changing column addresses of a portion of the read data, the portion of read data corresponding to a plurality of bits, and transmit the shift data to the page buffers, and a control circuit configured to control the page buffers, the sub-buffers, and the voltage generator to program the original data having n bits to each of memory cells of the first memory block, and program the shift data having N bits more than the n bits to each of memory cells of the second memory block, wherein n is greater than 0 and N is greater than 0, wherein the control circuit is configured to, when the read data is converted into the shift data, control the page buffers and the sub-buffers so that the plurality of bits of the portion of the read data is shifted from a first set of columns to a second set of columns in a predetermined direction.

An embodiment of the present disclosure may provide for a memory device. The memory device may include a first memory block and a second memory block, a peripheral circuit configured to program first data to the first memory block, read the first memory block, and program the first data or second data, obtained by converting at least one chunk of the first data, to the second memory block, the at least one chunk including a plurality of bits, and a control circuit configured to control the peripheral circuit to program the first data to the first memory block according to a single-level cell (SLC) scheme, convert the first data into the second data, and program the first data or the second data to the second memory block according to a multi-level cell (MLC) scheme depending on a cycling count of the first memory block.

An embodiment of the present disclosure may provide for a method of operating a memory device. The method may include storing read data, read from a first memory block, in page buffers divided into chunks that are units of error correction, transmitting the read data, stored in the page buffers, to sub-buffers, converting the read data stored in the sub-buffers into shift data by shifting the read data, transmitted to the sub-buffers, to sub-buffers corresponding to different chunks, transmitting the shift data, stored in the sub-buffers, to the page buffers, and programming the shift data, transmitted to the page buffers, to a second memory block, wherein each of the different chunks includes a plurality of bits.

An embodiment of the present disclosure may provide a method of operating a memory device, comprising storing data in single-level cell (SLC) memory cells of a first memory block; transferring the data to a buffer; converting the data in the buffer to generate shifted data; and storing the shifted data in multi-level cell (MLC) cells of a second memory block, wherein the data stored in the buffer is shifted by at least one chunk in a predetermined direction, each chunk corresponding to a plurality of bits, wherein the data stored in the SLC cells of the first memory block is stored in multiple pages of the first memory block, and wherein the shifted data stored in the MLC cells of the second memory block is stored in one page in the second memory block.

### BRIEF DESCRIPTION OF THE DRAWINGS

FIG. 1 is a diagram illustrating a memory system according to an embodiment of the present disclosure.

FIG. 2 is a diagram schematically illustrating a memory device according to an embodiment of the present disclosure.

FIG. 3 is a diagram illustrating in detail a memory device according to an embodiment of the present disclosure.

FIG. 4 is a diagram illustrating a page buffer according to an embodiment of the present disclosure.

FIG. 5 is a diagram illustrating a memory cell array according to an embodiment of the present disclosure.

FIG. 6 is a circuit diagram illustrating a memory block according to an embodiment of the present disclosure.

FIG. 7 is a flowchart illustrating a migration operation according to a first embodiment of the present disclosure.

FIG. 8 is a diagram illustrating threshold voltage distributions of memory cells according to an embodiment of the present disclosure.

FIGS. 9A to 9E are diagrams illustrating a migration operation according to embodiments of the present disclosure.

FIGS. 10A to 10C are diagrams illustrating a data shift operation according to an embodiment of the present disclosure.

FIG. 11 is a diagram illustrating a page to which shift data is programmed according to an embodiment of the present disclosure.

FIG. 12 is a diagram illustrating the number of fail bits in read data and shift data, each containing fail bits, according to an embodiment of the present disclosure.

FIGS. 13A to 13C are diagrams illustrating an embodiment of a sub-buffer group.

FIG. 14 is a flowchart illustrating a migration operation according to a second embodiment of the present disclosure.

FIG. 15 is a diagram illustrating a memory card system including a memory device according to an embodiment of the present disclosure.

FIG. 16 is a diagram illustrating a solid state drive (SSD) system including a memory device according to an embodiment of the present disclosure.

### DETAILED DESCRIPTION

Specific structural or functional descriptions, disclosed herein, are exemplified to describe embodiments according to the concept of the present disclosure. The embodiments according to the concept of the present disclosure should not be construed as being limited to embodiments described below, and may be modified in various forms and replaced with other equivalent embodiments.

Hereinafter, although the terms “first” and “second” may be used herein to describe various elements, these elements should not be limited by these terms. The terms are used to distinguish one element from other elements.

FIG. 1 is a diagram illustrating a memory system 1000 according to an embodiment of the present disclosure.

Referring to FIG. 1, the memory system 1000 may include a memory device 100, a controller 200, and a host 300. The memory device 100 may store data. The memory device 100 may be implemented as a nonvolatile memory device. The nonvolatile memory device may be a device in which stored data is retained even when power supply is interrupted. The memory device 100 may include memory blocks that operating according to different schemes. For example, the memory device 100 may include memory blocks which store data in memory cells according to a single-level cell (SLC) scheme, and may include other memory blocks which store data in memory cells according to a multi-level cell (MLC) scheme.

The controller 200 may perform communication between the host 300 and the memory device 100. The controller 200 may control the memory device 100 in response to a request received from the host 300. For example, when a request RQ for a program operation is received from the host 300, the controller 200 may generate a command CMD corresponding to the program operation and transmit the command CMD to the memory device 100. For example, when a request RQ for a read operation is received from the host 300, the controller 200 may generate a command CMD corresponding to the read operation and transmit the command CMD to the memory device 100. During the read operation, when data DATA read from the memory device 100 is output, the controller 200 may perform an error correction operation on the read data DATA. In the error correction operation, the read data DATA may be decoded on a chunk basis. That is, each chunk may be an error correction unit using an error correction code (ECC).

The host 300 may communicate with the memory device 100 through the controller 200 using an interface protocol such as peripheral component interconnect-express (PCI-e or PCIe), advanced technology attachment (ATA), serial ATA (SATA), parallel ATA (PATA), or serial attached SCSI (SAS). The interface protocol is not limited to the above-described examples, and may include various interfaces, such as universal serial bus (USB), multi-media card (MMC), enhanced small disk Interface (ESDI), or integrated drive electronics (IDE).

When the host 300 transmits data DATA, together with the request RQ corresponding to a program operation, to the controller 200, the controller 200 may generate a command CMD corresponding to the program operation in response to the request RQ corresponding to the program operation. The command CMD, corresponding to the program operation, and the data DATA may be transmitted to the memory device 100, and the memory device 100 may program the data DATA in response to the command CMD.

The memory device 100 according to the present disclosure may perform a program operation on a selected memory block and thereafter perform a migration operation in order to shorten the time required for the program operation and increase the storage capacity of the memory device 100. For the migration operation, the memory device 100 may program ‘n’ bits of data to each of memory cells included in a first memory block, may read the data programmed to the first memory block, may convert columns of the read data to generate shift data, and may program ‘N’ bits of the data more than ‘n’ bits of the data to each of the memory cells included in a second memory block using the shift data. Here, ‘n’ and ‘N’ may be natural numbers.

For example, when a command CMD for a program operation is received from the controller 200, the memory device 100 may program data DATA to the first memory block according to a single-level cell (SLC) scheme in order to increase the speed of the program operation. Since the single-level cell scheme is a scheme for programming 1 bit of data in one memory cell, the time required for the program operation may be relatively short. After the data DATA is programmed to the first memory block, the memory device 100 may compress the data stored in the first memory block and copy back the compressed data to the second memory block operating according to an MLC scheme to achieve increased storage capacity. The terms “first” and “second” in the first and second memory blocks may mean different memory blocks rather than meaning the arrangement order or positions of memory blocks.

During the migration operation, the memory device 100 may temporarily store read data, which is read from the first memory block, and may convert the read data into shift data by shifting the read data on a column basis. For example, the memory device 100 may convert the read data into shift data using a scheme for converting a portion of the data read from the memory cells in the same column into another column, thereby compressing the data. When the read data is converted into the shift data, the memory device 100 may program the shift data to the second memory block according to the multi-level cell (MLC) scheme. Because the multi-level cell (MLC) scheme is a scheme for programming 2 or more bits of data to one memory cell, the storage capacity of the memory device may be increased. That is, when the shift data is stored in the second memory block, the memory device 100 may secure a memory block corresponding to free status by erasing the first memory block. Thus, by performing the migration operation, the memory device is able to simultaneously achieve a fast program operation and increased storage capacity.

As described above, in case that the shift data, obtained by shifting a portion of read data read from the first memory block on a column basis, is copied back to the second memory block, a phenomenon in which the number of fail bits rapidly increases in a specific column may be prevented during a read operation on the second memory block to be subsequently performed.

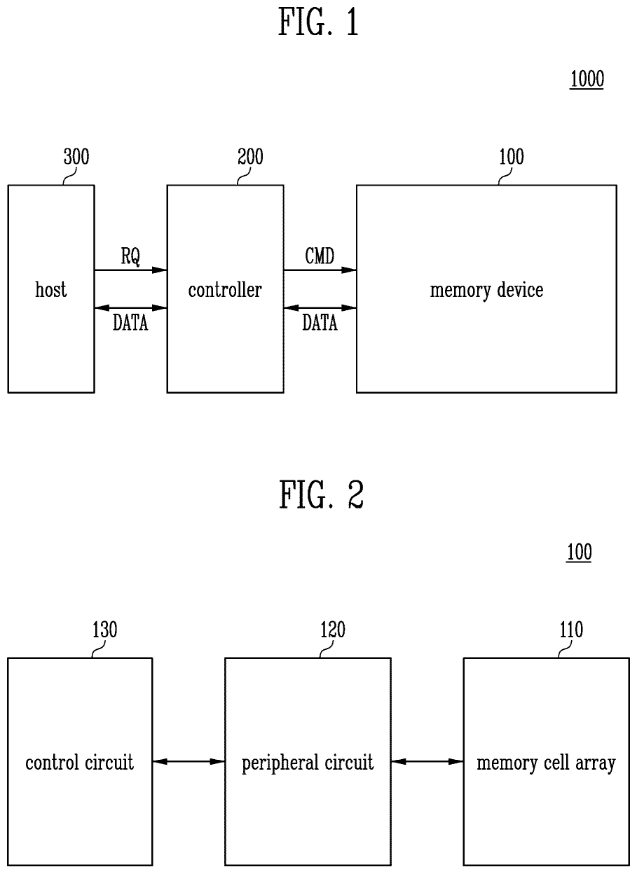

FIG. 2 is a diagram schematically illustrating the memory device 100 according to an embodiment of the present disclosure.

Referring to FIG. 2, the memory device 100 may include a memory cell array 110, a peripheral circuit 120, and a control circuit 130. The memory cell array 110 may store data. The peripheral circuit 120 may perform a program operation, a read operation, or an erase operation under the control of the control circuit 130. The control circuit 130 may control the peripheral circuit 120 in response to a command CMD output from a controller (e.g., 200 of FIG. 1). For example, the peripheral circuit 120 may receive data from the controller 200 and program the received data to a selected memory block of the memory cell array 110, under the control of the control circuit 130. The peripheral circuit 120 may read the selected memory block and temporarily store the read data under the control of the control circuit 130.

According to an embodiment of the present disclosure, the peripheral circuit 120 may generate shift data by shifting some columns of the read data under the control of the control circuit 130. For example, the control circuit 130 may generate the shift data by converting the read data so that the columns of read data, read from different pages, do not overlap each other. For example, the peripheral circuit 120 may convert the column of read data, read from a first page of the selected memory block, and may convert the column of read data, read from a second page of the selected memory block, not to overlap the converted column of the read data of the first page.

When the shift data is generated, the peripheral circuit 120 may program the shift data to another memory block operating according to a different scheme. For example, the peripheral circuit 120 may program data according to a single-level cell scheme or a multi-level cell (MLC) scheme under the control of the control circuit 130. That is, the peripheral circuit 120 may program some of memory blocks included in the memory device 100 according to the single-level cell (SLC) scheme, and may program other memory blocks according to the multi-level cell (MLC) scheme, under the control of the control circuit 130. When the program operation is performed according to the multi-level cell (MLC) scheme, the number of bits programmed to one memory cell may be changed, e.g., increased. For example, when the program operation is performed according to the multi-level cell (MLC) scheme, 2 bits of data, 3 bits of data, or 4 bits of data may be stored in one memory cell. According to the present embodiment, the number of bits stored in one memory cell is not limited to a specific number.

The peripheral circuit 120 may perform a read operation on memory blocks under the control of the control circuit 130. According to the program scheme for a memory block, the read operation may also be changed. For example, a memory block programmed according to the single-level cell (SLC) scheme may be read using the single-level cell scheme. A memory block programmed according to the multi-level cell (MLC) scheme may be read using the multi-level cell (MLC) scheme. Therefore, read voltages used for the read operation may be converted depending on the number of bits of data stored in one memory cell.

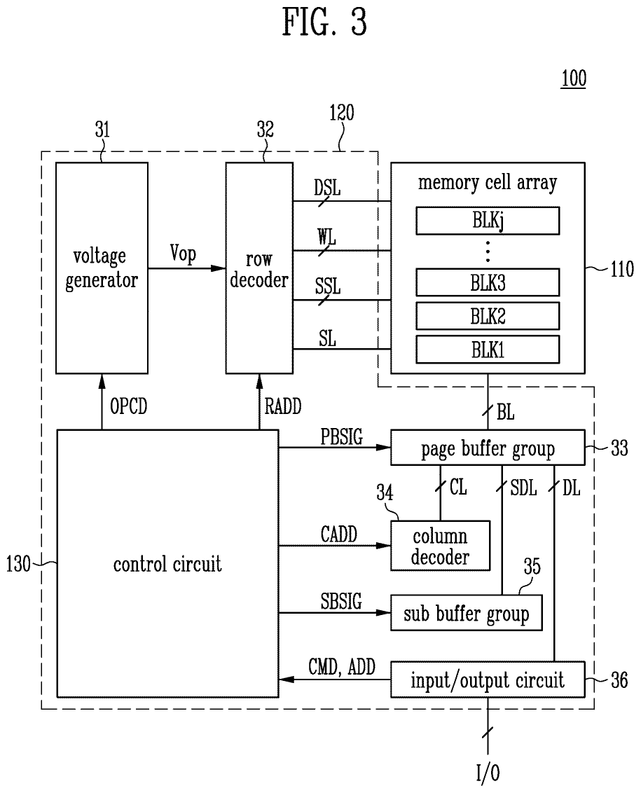

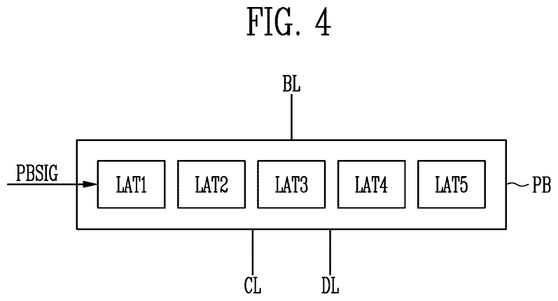

FIG. 3 is a diagram illustrating the memory device 100 according to an embodiment, and FIG. 4 is a diagram illustrating a page buffer according to an embodiment of the present disclosure.

Referring to FIG. 3, the memory device 100 may include a memory cell array 110, a peripheral circuit 120, and a control circuit 130. The memory cell array 110 may include first to j-th memory blocks BLK1 to BLKj. Each of the first to j-th memory blocks BLK1 to BLKj may include memory cells capable of storing data, some memory cells of which are programmed according to different schemes. Drain select lines DSL, word lines WL, source select lines SSL, a source line SL, and bit lines BL may be connected to each of the first to j-th memory blocks BLK1 to BLKj. The drain select lines DSL, the word lines WL, and the source select lines SSL may be connected to each of the first to j-th memory blocks BLK1 to BLKj, and the source line SL and the bit lines BL may be connected in common to the first to j-th memory blocks BLK1 to BLKj.

Each of the first to j-th memory blocks BLK1 to BLKj may be formed in a two-dimensional (2D) structure or a three-dimensional (3D) structure. Each memory block having a 2D structure may include memory cells arranged in a single layer and in parallel on a substrate. Each memory block having a 3D structure may include memory cells stacked on a substrate in a vertical direction. In the present embodiment, memory blocks formed in the 3D structure are disclosed by way of example.

According to a program scheme, each memory cell may store 1 bit of data or 2 or more bits of data. For example, a scheme for storing 1 bit of data in one memory cell is referred to as a single-level cell (SLC) scheme, and a scheme for storing 2 or more bits of data in one memory cell is referred to as a multi-level cell (MLC) scheme. Of multi-level cell (MLC) schemes, a scheme for storing 3 bits of data in one memory cell is referred to as a triple-level cell (TLC) scheme, and a scheme for storing 4 bits of data in one memory cell is referred to as a quad-level cell (QLC) scheme. In addition, 5 or more bits of data may be stored in one memory cell.

The peripheral circuit 120 may perform a program operation of storing data in the memory cell array 110, a read operation of outputting data stored in the memory cell array 110, and an erase operation of erasing data stored in the memory cell array 110 under the control of the control circuit 130. For example, the peripheral circuit 120 may include a voltage generator 31, a row decoder 32, a page buffer group 33, a column decoder 34, a sub-buffer group 35, and an input and output (input/output) circuit 36.

The voltage generator 31 may generate various operating voltages Vop that are used for a program operation, a read operation, or an erase operation in response to an operation code OPCD. For example, the voltage generator 31 may generate a program voltage, a turn-on voltage, a turn-off voltage, a verify voltage, a read voltage, a pass voltage, or an erase voltage in response to the operation code OPCD. The operating voltages Vop generated by the voltage generator 31 may have various levels, respectively. The operating voltages Vop may be applied to the drain select lines DSL, the word lines WL, the source select lines SSL, and the source line SL of a memory block selected through the row decoder 32. In one embodiment, a source voltage supplied to the source line SL may be generated by a circuit separate from the voltage generator 31.

The program voltage may be a voltage that is applied to a word line selected from among the word lines WL during a program operation. The program voltage may increase the threshold voltages of memory cells connected to the selected word line. The turn-on voltage may be applied to the drain select lines DSL or the source select lines SSL, and may be used to turn on drain select transistors or source select transistors. The drain select transistors may be coupled to different bit lines, and the source select transistors may be coupled to a source line set to a reference voltage, e.g., a ground voltage. The turn-off voltage may be applied to the drain select lines DSL or the source select lines SSL, and may be used to turn off the drain select transistors or the source select transistors.

The verify voltage may be used in a verify operation of determining whether the threshold voltages of selected memory cells have increased to a target level. The verify voltage may be set to various levels according to the target level, and may be applied to the selected word line.

The read voltage may be applied to the selected word line during a read operation performed on the selected memory cells. For example, the read voltage may be set to various levels according to the program scheme (e.g., an MLC scheme) for the selected memory cells.

The pass voltage may be a voltage that is applied to unselected word lines among the word lines WL during a program or read operation, and may be used to turn on memory cells connected to the unselected word lines. This prevents the unselected memory cells from being adversely affected during to a program operation performed on selected memory cells.

The erase voltages may be used in an erase operation of erasing the memory cells included in the selected memory block, and may be applied to one or more corresponding word lines WL. For example, during a migration operation, erase voltages may be supplied to erase data from a first memory block storing data according to an SLC scheme, which data has been copied back as compressed data in a second memory block according to an MLC scheme.

The row decoder 32 may transmit the operating voltages Vop to the drain select lines DSL, the word lines WL, the source select lines SSL, and the source line SL, which are connected to a memory block selected according to a row address RADD. For example, the row decoder 32 may be connected to the voltage generator 31 through global lines GL, and may be connected to the first to j-th memory blocks BLK1 to BLKj through the drain select lines DSL, the word lines WL, the source select lines SSL, and the source line SL. In an embodiment, the source line SL may be connected to a separate source line driver without being connected to the row decoder 32.

The page buffer group 33 may include page buffers connected to the first to j-th memory blocks BLK1 to BLKj through the bit lines BL. Because the page buffers are configured in the same manner, the page buffer PB will be described in detail with reference to FIG. 4.

Referring to FIG. 4, the page buffer PB may be connected to bit lines BL, column lines CL, and data lines DL. The page buffer PB may include first to fifth latches LAT1 to LAT5. The number of latches included in the page buffer PB may be changed depending on the memory device, e.g., depending on the number of bit lines BL.

The number of latches included in the page buffer PB may also be changed depending on the program method performed by the memory device. The number of latches included in the page buffer PB may be changed depending on the maximum number of bits of data stored in one memory cell. For example, when the memory device 100 is configured to perform a program operation according to a scheme selected from the single-level cell (SLC) scheme and the quad-level cell (QLC) scheme, the page buffer PB may include a number of latches corresponding to the quad-level cell (QLC) scheme. In the program method corresponding to the quad-level cell (QLC) scheme, 4 bits of data may be stored in one memory cell. Thus, at least five latches may be included in the page buffer PB, e.g., four latches for storing 4 bits of data and one latch used for a verify operation or a read operation.

During a program operation, the page buffer PB may receive data through the data lines DL in response to page buffer control signals PBSIG and signals that are input through the column lines CL. The first to fourth latches LAT1 to LAT4 may be used to store data to be programmed, and the fifth latch LAT5 may be used to sense data during a verify operation or a read operation. The page buffer PB may convert data stored in the first to fourth latches LAT1 to LAT4 in response to the page buffer control signals PBSIG.

Referring again to FIG. 3, the column decoder 34 may be configured such that data is transferred between the page buffer group 33 and the input/output circuit 36 in response to a column address CADD. For example, the column decoder 34 may be connected to the page buffer group 33 through the column lines CL, and may transmit enable signals through the column lines CL. The page buffers included in the page buffer group 33 may receive or output data through the data lines DL in response to the enable signals.

The sub-buffer group 35 may include a plurality of sub-buffers in which data can be stored. The sub-buffer group 35 may be connected to the page buffer group 33 through sub-data lines SDL. The sub-buffer group 35 may receive data from the page buffer group 33 through the sub-data lines SDL or transmit data to the page buffer group 33. The sub-buffer group 35 may convert data stored in the plurality of sub-buffers in response to sub-buffer control signals SBSIG. The sub-buffer group 35 may transfer data between different sub-buffers in response to the sub-buffer control signals SBSIG. For example, data may be shifted between the plurality of sub-buffers corresponding to different columns.

The input/output circuit 36 may receive or output a command CMD, an address ADD, or data through input/output lines I/O. For example, the input/output circuit 36 may transmit the command CMD and the address ADD, received from an external controller through the input/output lines I/O, to the control circuit 130, and may transmit the data, received from the controller (e.g., 200 of FIG. 1) through the input/output lines I/O, to the page buffer group 33. In one embodiment, the input/output circuit 36 may output data, received from the page buffer group 33, to the controller (e.g., 200 of FIG. 1) through the input/output lines I/O.

The control circuit 130 may output the operation code OPCD, the row address RADD, the page buffer control signals PBSIG, and the column address CADD in response to the command CMD and the address ADD from the input/output circuit 36. For example, when the command CMD input to the control circuit 130 is a command corresponding to a program operation, the control circuit 130 may control the devices included in the peripheral circuit 120 so that the program operation is performed on a memory block selected by the address ADD. When the command CMD input to the control circuit 130 is a command corresponding to a read operation, the control circuit 130 may control the devices included in the peripheral circuit 120 so that the read operation is performed on a memory block selected by the address and read data is output. When the command CMD input to the control circuit 130 is a command corresponding to an erase operation, the control circuit 130 may control the peripheral circuit 120 so that the erase operation is performed on a selected memory block.

The control circuit 130 may secure memory blocks in free status through a migration operation during a program operation. During a migration operation, the control circuit 130 may control the peripheral circuit 120 to program data, input to the memory device 100 through the input/output lines I/O, to a memory block selected from among the first to j-th memory blocks BLK1 to BLKj according to the single-level cell (SLC) scheme. After the program operation according to the single-level cell (SLC) scheme is performed, the control circuit 130 may control the peripheral circuit 120 to read data from the memory block on which the program operation is performed and store the read data in the page buffer group 33.

According to an embodiment of the present disclosure, the control circuit 130 may control the peripheral circuit 120 to convert (e.g., compress) some columns of the read data stored in the page buffer group 33. For example, the control circuit 130 may control the peripheral circuit 120 to transmit a portion of the read data, stored in the page buffers of the page buffer group 33, to different page buffers. In performing this operation, the control circuit 130 may control the peripheral circuit 120 to convert column information of some read data among pieces of read data stored in the page buffers. The converted read data is defined as shift data. The control circuit 130 may control the peripheral circuit 120 to program the shift data to memory cells operating according to the multi-level cell (MLC) scheme, based on the data stored in the page buffer group 33.

For example, the control circuit 130 may control the peripheral circuit 120 to program the shift data into memory cells of a memory block operating according to the quad-level cell (QLC) scheme, among multi-level cell (MLC) schemes. The control circuit 130 may control the peripheral circuit 120 so that the shift data is programmed to a memory block that is not operating according to the single-level cell (SLC) scheme, i.e., to a memory block selected from among the remaining memory blocks other than a memory block to which data is programmed according to the single-level cell (SLC) scheme.

After the program operation according to the quad-level cell (QLC) scheme is completed, the control circuit 130 may control the peripheral circuit 120 so that an erase operation is performed on the first memory block, e.g., the data block to which the data was initially programmed according to the single-level cell (SLC) scheme. Along with the compression performed to generate the shift data, erasing the first memory block operating according to the single-level cell (SLC) structure serves to further increase the storage capacity of the memory device 100. During the read operation, the control circuit 130 may control the peripheral circuit 120 so that a read operation is performed on the second memory block storing the shift data, e.g., the memory block operating according to the quad-level cell (QLC) scheme.

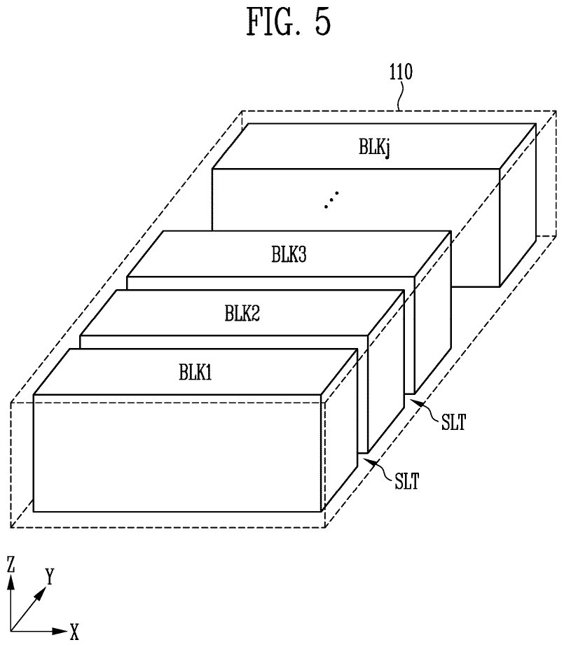

FIG. 5 is a diagram illustrating a memory cell array according to an embodiment of the present disclosure.

Referring to FIG. 5, first to j-th memory blocks BLK1 to BLKj included in the memory cell array 110 may be arranged to be spaced apart from each other in a Y direction. Some memory blocks among the first to j-th memory blocks BLk1 to BLKj may be designated to be programmed or read according to the single-level cell (SLC) scheme, and other memory blocks may be designated to be programmed or read according to the multi-level cell (MLC) scheme. Memory blocks designated to be operated according to the single-level cell (SLC) or a multi-level cell (MLC) scheme may be converted. The peripheral circuit (e.g., 120 of FIG. 3) may be disposed under the memory cell array 110. For example, the peripheral circuit (e.g., 120 of FIG. 3) may be located between a substrate and the memory cell array 110.

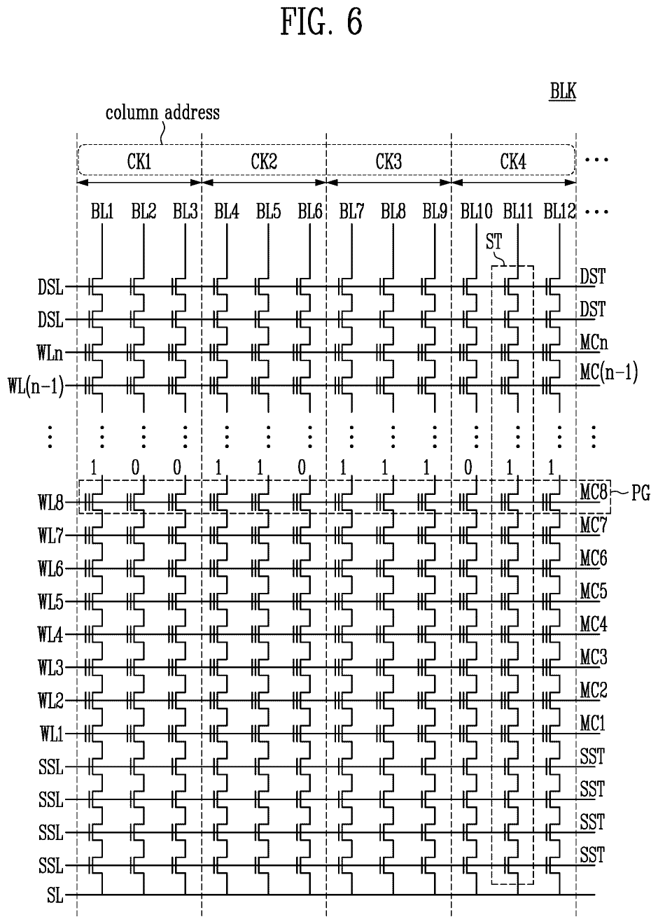

FIG. 6 is a circuit diagram illustrating a memory block BLK which may represent the structure of the memory blocks BLK1 to BLKj in FIG. 5.

Referring to FIG. 6, the memory block BLK may include strings ST connected between a source line SL and bit lines BL1 to BL12 , . . . . The strings ST are connected in common to the source line SL (which may be coupled to a ground voltage) and are connected to the bit lines BL1 to BL12, . . . , respectively. Each of the strings ST may include source select transistors SST, memory cells MC1 to MCn, and drain select transistors DST. The source select transistors SST may be connected between the source line SL and first memory cells MC1. The first to n-th memory cells MC1 to MCn may be connected between the source select transistors SST and the drain select transistors DST. The drain select transistors DST may be connected between the n-th memory cells MCn and the bit lines BL1 to BL12, . . . . Gates of the source select transistors SST may be connected to source select lines SSL. Gates of the first to n-th memory cells MC1 to MCn may be connected to first to n-th word lines WL1 to WLn, respectively. Gates of the drain select transistors DST may be connected to the drain select lines DSL. A group of memory cells connected to the same word line may be a page (PG). Each of program and read operations may be performed on a page (PG) basis. The numbers of the source select transistors SST, the memory cells MC1 to MCn, and the drain select transistors DST, included in the memory block BLK, may vary depending on the memory device.

The strings ST may be selected according to a column address, and the first to n-th word lines WL1 to WLn may be selected according to a row address.

The memory cells included in the same page (PG) may be divided into units of chunks, e.g., bits stored in a consecutive number of memory cells. For example, memory cells connected to the first to third bit lines BL1 to BL3 may be included in a first chunk CK1, memory cells connected to fourth to sixth bit lines BL4 to BL6 may be included in a second chunk CK2, memory cells connected to seventh to ninth bit lines BL7 to BL9 may be included in a third chunk CK3, and memory cells connected to the tenth to twelfth bit lines BL10 to BL12 may be included in a fourth chunk CK4. The first to fourth chunks CK1 to CK4 may be included in a column address. For example, it is assumed that a page (PG) corresponding to the eighth word line WL8 is a selected page and data, stored in memory cells sequentially corresponding to the first to twelfth bit lines BL1 to BL12 , is ‘1 0 0 1 1 0 1 1 1 0 1 1’. In this case, the data stored in the selected page may be divided into ‘1 0 0’, ‘1 1 0’, ‘1 1 1’ and ‘0 1 1’ depending on respective ones of the first to fourth chunks CK1 to CK4.

In the migration operation according to the present embodiment, the column address of data stored in the page (PG) is converted on a chunk basis, e.g., a plurality of bits stored in a plurality of memory cells. The memory cells may be a consecutive number of memory cells. A migration operation according to the present embodiment will be described in detail below.

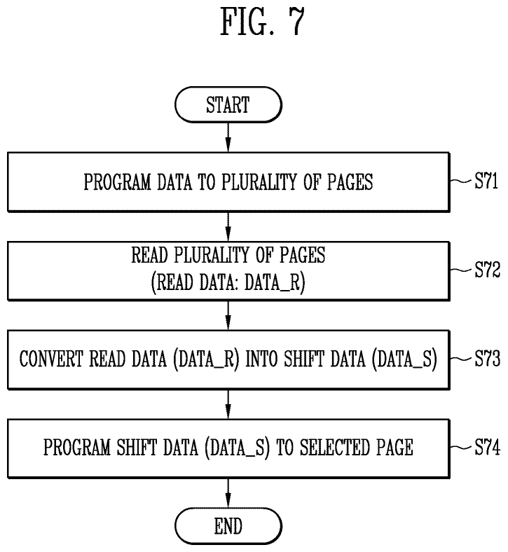

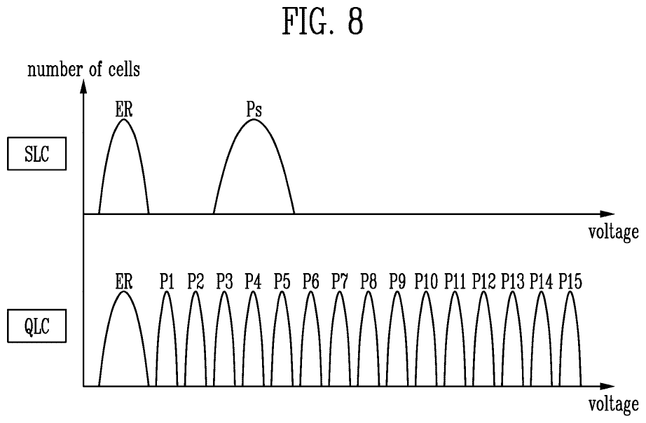

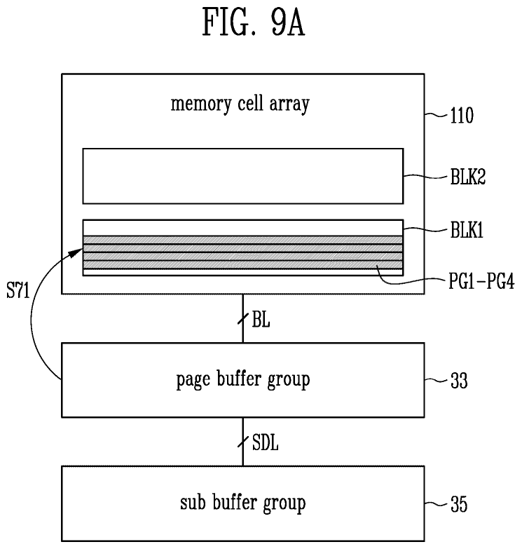

FIG. 7 is a flowchart illustrating a migration operation according to a first embodiment of the present disclosure, and FIG. 8 is a diagram illustrating threshold voltage distributions of memory cells according to the first embodiment.

Referring to FIGS. 7 and 8, when data output from a controller (e.g., controller 200) is received, at S71, data is programmed to a plurality of pages included in a selected memory block. At S71, the memory device may perform a program operation to store the received data according to a single-level cell (SLC) scheme. For example, at S71, the program operation may be performed in a scheme for storing each 1 bit of data in one separate memory cell coupled to the selected word line of the memory block.

In performing the program operation according to the single-level cell (SLC) scheme, the memory cells may be identified as a memory cell in an erase state ER or in a program state Ps. When the threshold voltages of memory cells are divided into the erase state ER and the program state Ps, the program operation according to the single-level cell (SLC) scheme is completed. Because the data is stored in memory cells of a page operating according to the single-level cell (SLC) scheme, the program operation may be completed faster than the program operation according to the multi-level cell (MLC) scheme for the following reason.

Among the multi-level cell (MLC) schemes, a quad-level cell (QLC) scheme will be described by way of example. Memory cells programmed according to the quad-level cell (QLC) scheme may be in the erase state ER, or may be programmed to any one of first to fifteenth program states P1 to P15. Therefore, the program operation performed according to the quad-level cell (QLC) scheme requires a longer time than the single-level cell (SLC) scheme. Therefore, the memory device 100 may program data by performing a program operation according to the single-level cell (SLC) scheme earlier than a program operation according to the multi-level cell (MLC) scheme. In the program operation according to the single-level cell (SLC) scheme, each 1 bit of data may be stored in one separate memory cell, whereas in the program operation according to the quad-level cell (QLC) scheme, 4 or more bits of data may be stored in each memory cell.

When the program operation according to the single-level cell (SLC) scheme is completed, at S72, the memory device may read a plurality of programmed pages from the selected memory block. The data read from the plurality of pages may be stored in a page buffer group, e.g., page buffer group 33 in FIG. 3. In the present embodiment, it is assumed that data stored in the page buffer group through the read operation is read data DATA_R.

At S73, the memory device may convert the read data DATA_R stored in the page buffer group into shift data DATA_S by shifting (or compressing) a portion of the read data DATA_R. For example, the portion of the read data DATA_R may be shifted on a chunk basis, and may then be converted into the shift data DATA_S.

When the read data DATA_R is converted into the shift data DATA_S, at S74, the memory device may program the shift data DATA_S to a selected page included in another memory block. For example, the memory device may select a memory block set in the quad-level cell (QLC) scheme, and may program the shift data DATA_S to a page selected from among pages included in the selected memory block according to the quad-level cell (QLC) scheme.

After performing S74, the memory device may perform an erase operation on the memory block from which the read data DATA_R is read, e.g., the memory block which was initially selected to program the data according to the single-level cell (SLC) scheme. Because the memory block on which the erase operation is performed is designated as a block having a free status, it may be selected again during a subsequent program operation according to the single-level cell (SLC) scheme. Thus, according to embodiments of the present disclosure, the memory device 100 may simultaneously achieve rapid programming and increased storage capacity.

The migration operation, described above with reference to FIG. 8, will be now described in detail.

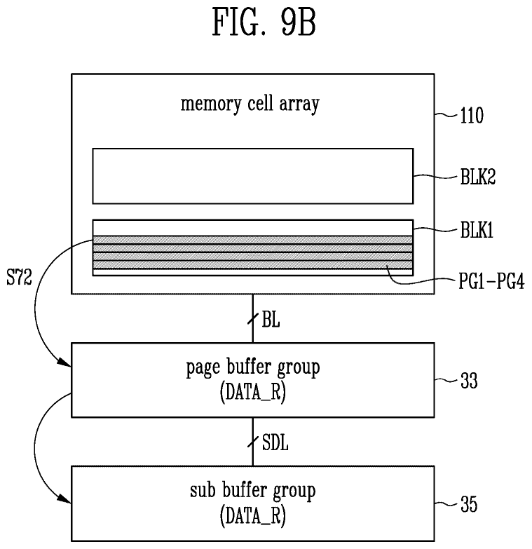

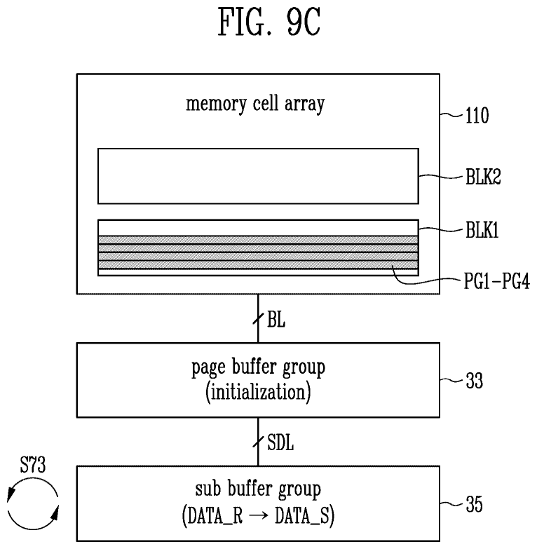

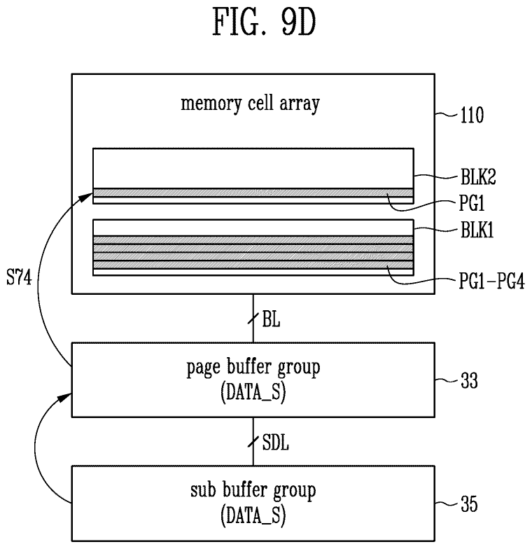

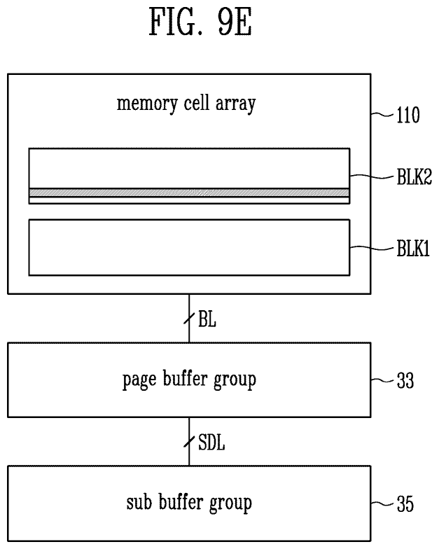

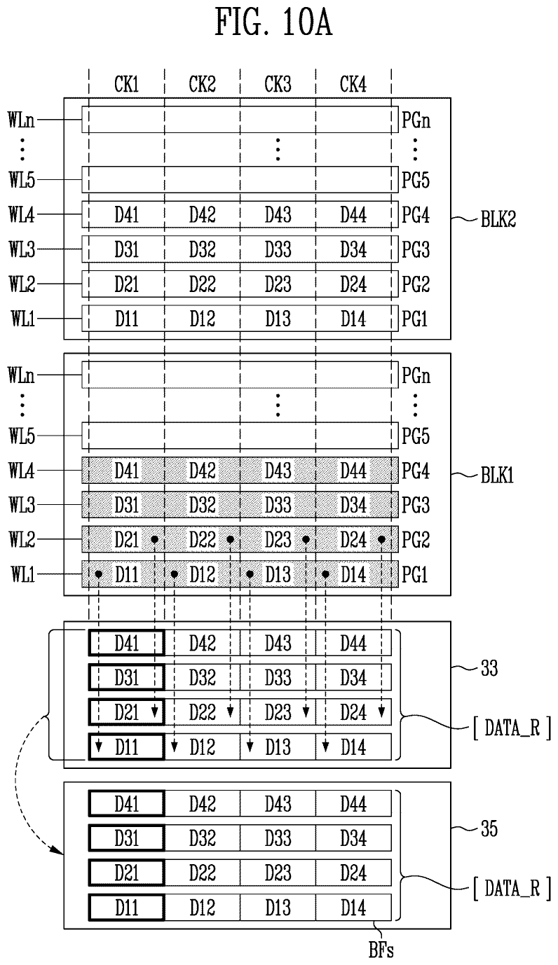

FIGS. 9A to 9E are diagrams illustrating a migration operation according to an embodiment of the present disclosure.

Referring to FIGS. 8 and 9A, it is assumed that, among memory blocks included in the memory cell array 110, a first memory block BLK1 is a block that is set to the single-level cell (SLC) scheme and a second memory block BLK2 is a block that is set in multi-level cell (MLC) scheme, e.g., a quad-level cell (QLC) scheme. At S71, data is programmed into memory cells of the first memory block BLK1 according to the single-level cell (SLC) scheme, and thus the first memory block BLK1 may be selected. The data may be programmed on a page basis. That is, when the data to be programmed is input to the page buffer group 33, the memory device may perform a program operation by selectively applying a program-enable voltage and a program-inhibit voltage to bit lines BL depending on the data input to the page buffer group 33. The program-enable voltage may be applied to memory cells to be programmed and the program-inhibit voltage may be applied to memory cells that are not to be programmed in the first memory block BLK1.

The memory device may then apply a program voltage to a word line selected from among word lines connected to the first memory block BLK1. For example, when a first page PG1 is selected, the program voltage may be applied to a word line connected to the first page PG1, whereas when a second page PG2 is selected, the program voltage may be applied to a word line connected to the second page PG2. In this manner, data may be rapidly programmed to the first to fourth pages PG1 to PG4 included in the first memory block BLK1 according to the single-level cell (SLC) scheme. Whenever the selected page is changed, data in the page buffer group 33 is changed. Thus, the voltage applied to the bit lines BL is also changed depending on the data in the page buffer group 33. In an embodiment described above with reference to FIG. 9A, data is programmed to the first to fourth pages PG1 to PG4 of the first memory block BLK1, but the number of selected pages may be changed depending on the capacity of data to be programmed.

Referring to FIGS. 8 and 9B, when the program operation on the first memory block BLK1 is completed, a read operation is performed at S72. For example, during the read operation, read data DATA_R, sensed from the first to fourth pages PG1 to PG4 of the first memory block BLK1 may be stored in the page buffer group 33. The read data DATA_R stored in the page buffer group 33 may be transmitted to the sub-buffer group 35.

Referring to FIGS. 8 and 9C, when the read data DATA_R stored in the page buffer group 33 is transmitted to the sub-buffer group 35, the latches included in the page buffer group 33 may be initialized. When the read data DATA_R is stored in the sub-buffer group 35, S73 is performed. At S73, the memory device converts the read data DATA_R, stored in the sub-buffer group 35, into shift data DATA_S. For example, among pieces (e.g., bits) of data included in the read data DATA_R, data read from at least one of the first to fourth pages PG1 to PG4 may be converted in a column direction. Here, data conversion may be performed on a chunk basis.

Referring to FIGS. 8 and 9D, when the read data DATA_R stored in the sub-buffer group 35 is converted into the shift data DATA_S, S74 is performed. At S74, the memory device may transmit the shift data DATA_S, stored in the sub-buffer group 35, to the page buffer group 33, and may program the shift data DATA_S, transmitted to the page buffer group 33, to the second memory block BLK2 which is programmed according to an MLC scheme.

In one embodiment, at S74, the shift data DATA_S may be programmed according to the quad-level cell (QLC) scheme. In this case, each chunk in the data to be converted may have four bits. During the program operation in the quad-level cell (QLC) scheme, 4 bits of data may be stored in one memory cell in the second memory block BLK2. Thus, among pieces (e.g., bits) of data included in the shift data DATA_S, 4 bits of data corresponding to the same column may be programmed to a memory cell corresponding to the same column among the memory cells included in the first page of the second memory block BLK2. That is, data stored in the first to fourth pages PG1 to PG4 of the first memory block BLK1 may be copied back to the first page PG1 of the second memory block BLK2, thereby effectively compressing the data.

Referring to FIGS. 8 and 9E, when S74 is completed, the memory device may secure a memory block having a free status (e.g., a memory block eligible to store data) in the memory cell array 110 by performing an erase operation on the first memory block BLK1. The sub-buffer group 35 and the page buffer group 33 may be initialized.

An operation of shifting the column of data on a chunk basis will be descried in detail below.

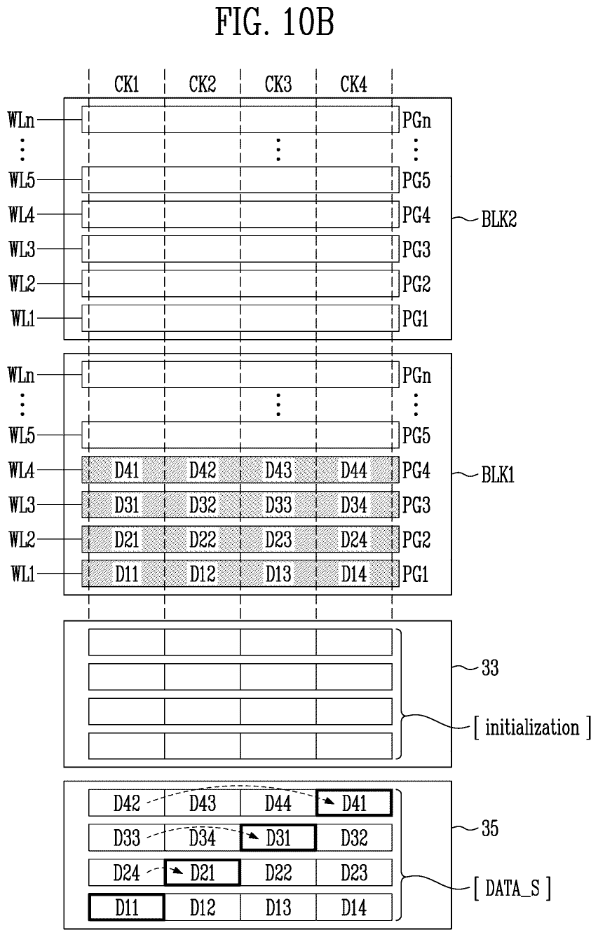

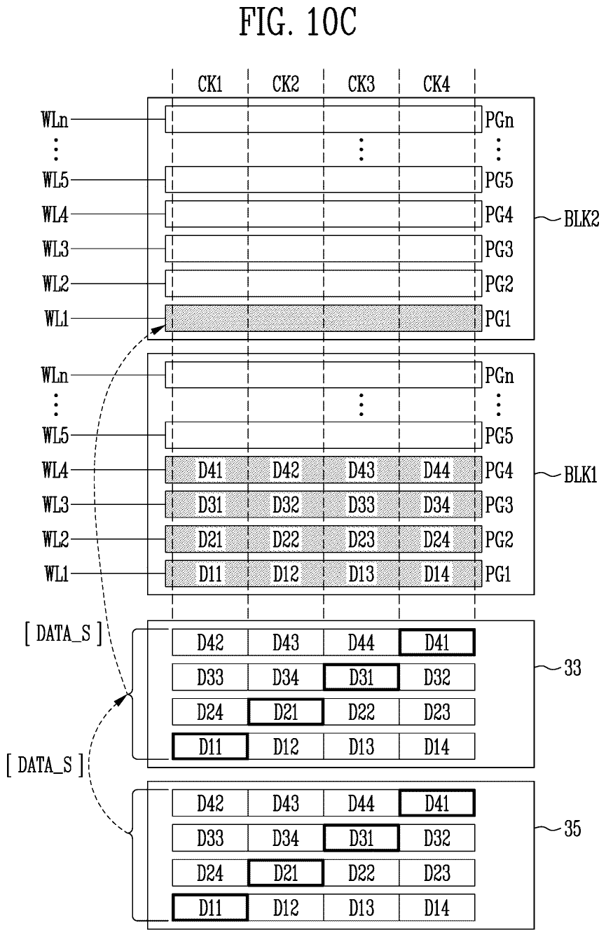

FIGS. 10A to 10C are diagrams illustrating in detail the data shift operation according to an embodiment of the present disclosure.

Referring to FIGS. 9B and 10A, data (e.g., D11 to D44) read from the first to fourth pages PG1 to PG4 of the first memory block BLK1 may be stored in different latches in the page buffer group 33. For example, among pieces of data stored in the first page PG1 of the first memory block BLK1, 11-th data D11 corresponding to a first chunk CK1 may be stored in area corresponding to a first page PG1 and a first chunk CK1 in the page buffer group 33. Among the pieces of data stored in the first page PG1 of the first memory block BLK1, 12-th data D12 corresponding to a second chunk CK2 may be stored in an area corresponding to the first page PG1 and a second chunk CK2 in the page buffer group 33. The 13-th data D13 stored in the first memory block BLK1 and corresponding to a third chunk CK3 may be stored in an area corresponding to the first page PG1 and a third chunk CK3 in the page buffer group 33. And, the 14-th data D14 stored in the first memory block BLK1 and corresponding to a fourth chunk CK4 may be stored in an area corresponding to the first page PG1 and a fourth chunk CK4 in the page buffer group 33.

Among pieces of data stored in the second page PG2 of the first memory block BLK1, 21-th data D21 corresponding to a first chunk CK1 may be stored in area corresponding to a second page PG2 and a first chunk CK1 in the page buffer group 33. Also, among the pieces of data stored in the second page PG2 of the first memory block BLK1, 22-th data D22 corresponding to a second chunk CK2 may be stored in an area corresponding to a second page PG2 and a second chunk CK2 in the page buffer group 33. In addition, 23-rd data D23 corresponding to a third chunk CK3 and 24-th data corresponding to the fourth chunk CK4 of the second page may be stored in corresponding portions of the page buffer group 33. The data stored in subsequent pages (PG3 and PG4) may then be stored in corresponding portions of the page buffer group 33 on a chunk basis.

Among pieces of data stored in the first to fourth pages PG1 to PG4, 11-th, 21-th, 31-th, and 41-th data D11, D21, D31, and D41 corresponding to the first chunk CK1 may be pieces of data stored in memory cells for which the same column address is designated. Among pieces of data stored in the first to fourth pages PG1 to PG4, 12-th, 22-th, 32-th, and 42-th data D12, D22, D32, and D42 corresponding to the second chunk CK2 may be pieces of data stored in memory cells for which the same column address is designated. Among pieces of data stored in the first to fourth pages PG1 to PG4, 13-th, 23-th, 33-th, and 43-th data D13, D23, D33, and D43 corresponding to the third chunk CK3 may be pieces of data stored in memory cells for which the same column address is designated. Among pieces of data stored in the first to fourth pages PG1 to PG4, 14-th, 24-th, 34-th, and 44-th data D14, D24, D34, and D44 corresponding to the fourth chunk CK4 may be pieces of data stored in memory cells for which the same column address is designated.

Therefore, as in the case of the data stored in the first memory block BLK1, the read data DATA_R stored in the page buffer group 33 may be divided into units of pages and chunks, e.g., the data stored in the first memory block BLK1 may be transferred to the page buffer group 33 according to the same arrangement and order. The read data DATA_R stored in the page buffer group 33 may be transmitted to the sub-buffer group 35, also in the same arrangement and order, e.g., in units of pages and chunks. The sub-buffer group 35 may include a number of sub-buffers BFs identical to the number of page buffers included in the page buffer group 33. Therefore, all of the read data DATA_R stored in the page buffer group 33 may be transmitted to the sub-buffer group 35.

Referring to FIGS. 9C and 10B, after the read data DATA_R is transmitted to the sub-buffer group 35, the page buffer group 33 may be initialized. For example, latches respectively included in the page buffers of the page buffer group 33 may be initialized in preparation for a shift operation to be performed for generating shift data.

The data shift operation may be performed on a chunk basis in a column direction. For example, data corresponding to at least one page among different pages may be shifted on a chunk basis. That is, in the same page, the column of data may be converted (or shifted) on a chunk basis. When data is converted in a plurality of pages, the data may be shifted such that the columns of pieces of data converted in different pages do not overlap each other. In accordance with one or more embodiments a “piece of data” as used herein may correspond to 2 or more bits.

For example, among pieces of data stored in the sub-buffer group 35, data corresponding to the first page PG1 may be maintained, e.g., none of the pieces of data are shifted in the first page PG1. Thus, the data of the first page PG1 in the page buffer group 33 are stored as D11, D12, D13, and D14.

The columns of pieces of data corresponding to the second to fourth pages PG2 to PG4 may be sequentially converted (shifted) in units of chunks. Specifically, among pieces of data stored in the sub-buffer group 35, each of the columns of 21-th, 22-th, 23-th, and 24-th data D21, D22, D23, and D24 corresponding to the second page PG2 may be converted into the unit of one chunk, e.g., shifted one position, or chunk, to the right. That is, 21-th data D21 included in the first chunk CK1 may be converted (shifted in position) into a second chunk CK2, 22-th data D22 included in the second chunk CK2 may be converted (shifted in position) into a third chunk CK3, 23-th data D23 included in the third chunk CK3 may be converted into a fourth chunk CK4, and 24-th data D24 included in the fourth chunk CK4 may be converted into a first chunk CK1.

Among pieces of data stored in the sub-buffer group 35, the columns of 31-th, 32-th, 33-th, and 34-th data D31, D32, D33, and D34 corresponding to the third page PG3 may be converted into units of two chunks, e.g., shifted two positions, or chunks, to the right. That is, 31-th data D31 included in the first chunk CK1 may be converted into data of a third chunk CK3, 32-th data D32 included in the second chunk CK2 may be converted into data of a fourth chunk CK4, 33-th data D33 included in the third chunk CK3 may be converted into data of a first chunk CK1, and 34-th data D34 included in the fourth chunk CK4 may be converted into data of a second chunk CK2.

Among the pieces of data stored in the sub-buffer group 35, the columns of 41-th, 42-th, 43-th, and 44-th data D41, D42, D43, and D44 corresponding to the fourth page PG4 may be converted into units of three chunks, e.g., shifted three positions, or chunks, to the right. That is, 41-th data D41 included in the first chunk CK1 may be converted into a fourth chunk CK4, 42-th data D42 included in the second chunk CK2 may be converted into a first chunk CK1, 43-th data D43 included in the third chunk CK3 may be converted into a second chunk CK2, and 44-th data D44 included in the fourth chunk CK4 may be converted into a third chunk CK3.

As described above, when pieces of data respectively corresponding to pages are converted into (shifted in) units of chunks, the columns of pieces of data corresponding to different pages are mixed. That is, in the first memory block BLK1, the 11-th, 21-th, 31-th, and 41-th data D11, D21, D31, and D41 are designated as having the same column address corresponding to the first chunk CK1, but in the shift data DATA_S stored in the sub-buffer group 35, the 11-th, 21-th, 31-th, and 41-th data D11, D21, D31, and D41 are converted into (shift to have) column addresses corresponding to different chunks.

In the case of a read operation in which the above-described data shift operation is not performed, the controller (e.g., 200 of FIG. 1) performs an error correction operation on the read data. In the error correction operation, the read data may be decoded on a chunk basis. Therefore, when fail bits are concentrated in a specific chunk of the read data, error decoding on the corresponding chunk fails, and thus the read operation may also fail.

However, as described above in the above embodiment, when the read data DATA_R is converted into shift data DATA_S by the data shift operation, the columns of data corresponding to different pages are converted and therefore are different from the columns of data in the first memory block BLK1. Thus, fail bits that may be concentrated in a specific chunk in the unshifted data are distributed to other chunks in the shifted data. As a result, the probability of success in the error correction operation may be increased.

Referring to FIGS. 9D and 10C, the shift data DATA_S, stored in the sub-buffer group 35, may be transmitted to the page buffer group 33, and the shift data DATA_S, transmitted to the page buffer group 33, may be programmed to the first page PG1 of the second memory block BLK2. That is, when the second memory block BLK2 is set to be programmed according to a quad-level cell (QLC) scheme, the shift data DATA_S transmitted to the page buffer group 33 may be programmed to a single selected page among pages included in the second memory block BLK2. Thus, the data stored in four pages PG1 to PG2 in the first memory block BLK1 are stored in a single page of the second memory block BLK2 in their converted (or shifted) order. Data stored in the first page PG1 of the second memory block BLK2 will be described in detail below.

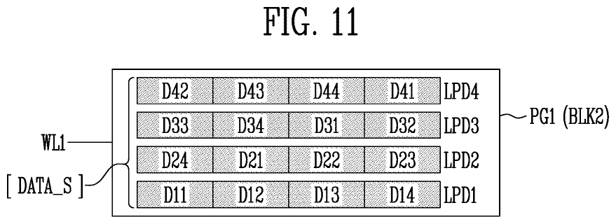

FIG. 11 is a diagram illustrating a page PG1 to which shift data is programmed in the second memory block BLK2. In this case, the four pages of data PG1 to PG4 stored in the first memory block BLK1 are able to be stored in the first page PG1 of the second memory block BLK2, as a result of the second memory block having MLC cells.

Referring to FIGS. 10C and 11, the first page PG1 of the second memory block BLK2 refers to a physical page. That is, the first page PG1 refers to a group of memory cells connected to the first word line WL1. The first page PG1 may be set such that first to fourth pieces of logical data LPD1 to LPD4 are stored. Because the first to fourth pieces of logical page data LPD1 to LPD4 are logical concept of data, memory cells to which the first to fourth pieces of logical page data LPD1 to LPD4 are programmed may have threshold voltage distributions such as those of the quad-level cell (QLC), described above with reference to FIG. 8, depending on the combination of the first to fourth pieces of logical page data LPD1 to LPD4.

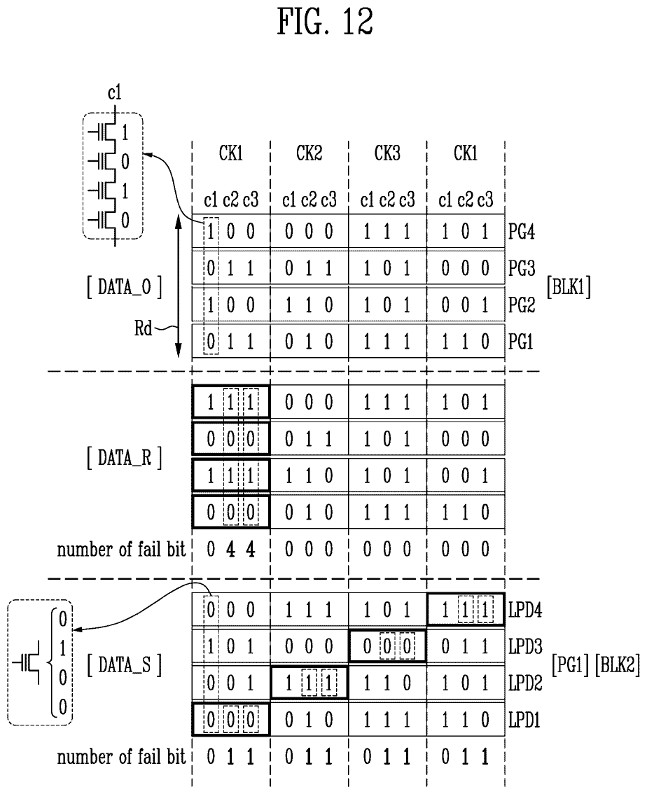

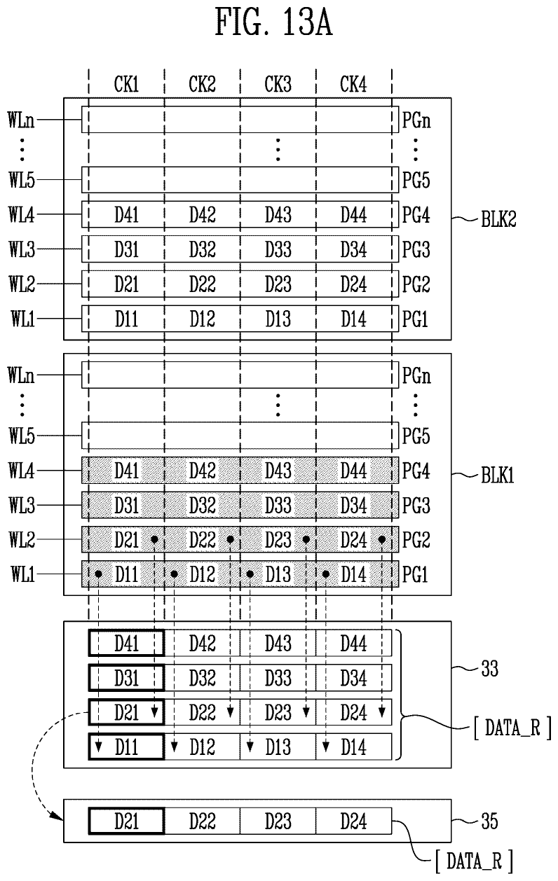

FIG. 12 is a diagram illustrating the number of fail bits in read data and shift data, each containing fail bits.

Referring to FIGS. 10C and 12, original data DATA_O is data stored in first to fourth pages PG1 to PG4 of a first memory block BLK1, read data DATA_R is data read from the first memory block BLK1 and stored in the page buffer group 33, and shift data DATA_S is data stored in the first page PG1 of a second memory block BLK2. Also, among memory cells included in one page, three memory cells are included in one chunk.

The first to fourth pages PG1 to PG4 are arranged in a row direction Rd. Therefore, memory cells arranged in the row direction may be included in the same string, and strings may correspond to different first to third columns c1 to c3, respectively. For example, data corresponding to the first column c1 in the first chunk CK1 may be data of memory cells included in the same string.

In this example, fail bits are concentrated in the first chunk CK1 in the read data DATA_R that is read by the read operation on the first memory block BLK1, and no fail bits are present in the remaining second to fourth chunks CK2 to CK4. If a read operation is subsequently performed on the second memory block BLK2 after the read data DATA_R is programmed to the second memory block BLK2, an error correction operation fails due to the large number of fail bits in the first chunk CK1, thus resulting in failure in the read operation. For example, the case where the allowable number of fail bits in the error correction operation is ‘2’ will be described. The fail bits included in the first chunk are indicated in the dotted boxes. Thus, the number of fail bits detected in the first chunk CK1 of the read data DATA_R is ‘8,’ which is greater than the allowable number of fail bits (2) for the error correction operation. As a result, the read operation may fail due to the excessive number of fail bits in the first chunk CK1, even when no fail bits are present in the second to fourth chunks CK2 to CK4.

As in the case of the above-described embodiment, when the read data DATA_R is converted into shift data DATA_S, chunks including fail bits may be distributed across different chunk positions in the data stored in the second memory block BLK2. For example, when the shift data DATA_S is programmed to the first page PG1 of the second memory block BLK2, 4 bits of data stored in different memory (SLC) cells corresponding to the same column (e.g., c1) in the first memory block BLK1 may be programmed to one memory (QLC) cell of the second memory block BLK2. Thus, the storage capacity of the memory device may be increased.

In addition, because data in the first chunk CK1 in which the number of fail bits is ‘8’ is distributed on a chunk basis, the number of fail bits in each of the first to fourth chunks CK1 to CK4 of data stored in the second memory block BLK2 may be ‘2’. That is, even if the total number of fail bits in the read data DATA_R is identical to the total number of fail bits in the shift data DATA_S, the fail bits are distributed across different chunks in the shift data DATA_S. Thus, no chunk of data stored in the second memory block has a number of fail bits that exceed the allowable number of fail bits for the error correction operation. Therefore, during a read operation on the second memory block BLK2 in which the shift data DATA_S is stored, the probability that the error correction operation will succeed may increase.

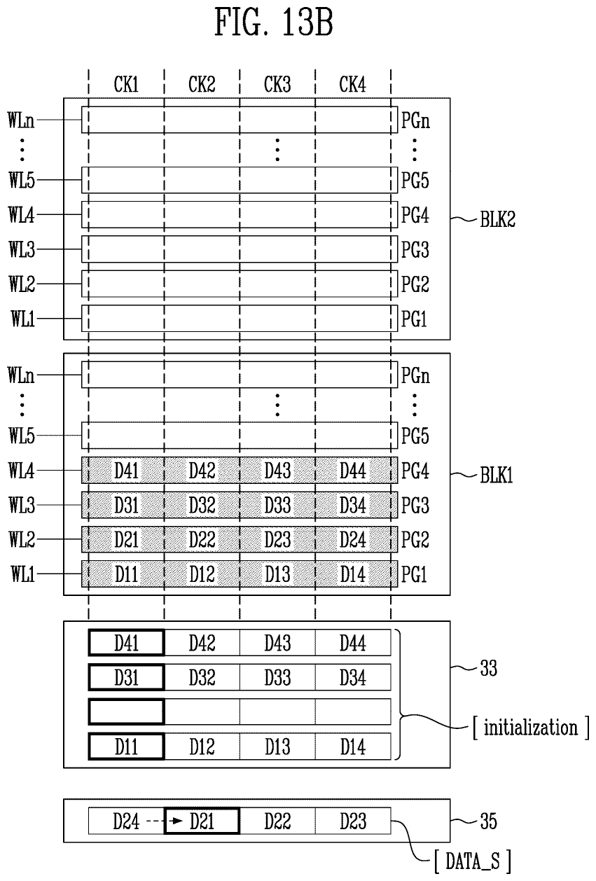

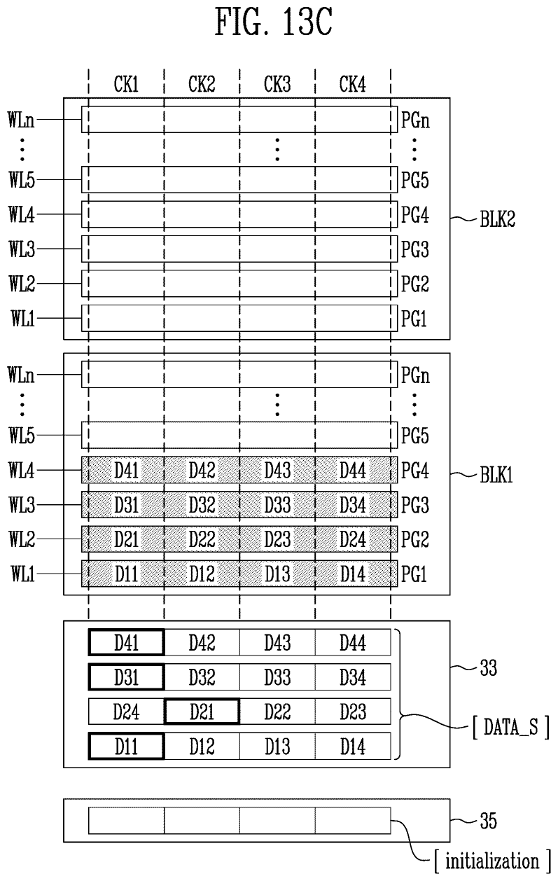

FIGS. 13A to 13C are diagrams illustrating an embodiment of a sub-buffer group according to an embodiment of the present disclosure.

Referring to FIG. 13A, the sub-buffer group 35 may include sub-buffers corresponding to page buffers included in one row among page buffers included in the page buffer group 33. That is, the size of the memory device may be reduced by reducing the number of sub-buffers included in the sub-buffer group 35.

Therefore, among pieces of read data DATA_R stored in the page buffer group 33, data stored in page buffers included in a selected row may be transmitted to the sub-buffer group 35. For example, 21-th, 22-th, 23-th, and 24-th data D21, D22, D23, and D24 stored in the page buffer group 33 may be transmitted to the sub-buffer group 35. The data D11, D12, D13, and D14 are not converted (or shifted) in this example, and therefore are not transmitted to the sub-buffer group 35.

Referring to FIG. 13B, when the 21-th, 22-th, 23-th, and 24-th data D21, D22, D23, and D24 are transmitted from the page buffer group 33 to the sub-buffer group 35, the page buffers in which the 21-th, 22-th, 23-th, and 24-th data D21, D22, D23, and D24 are stored may be initialized. The 21-th, 22-th, 23-th, and 24-th data D21, D22, D23, and D24 transmitted to the sub-buffer group 35 may be converted into shift data DATA_S by a data shift operation. In this example, the data transmitted to the sub-buffer group 35 is shifted one chunk position to the right. Thus, the order of the data stored in the sub-buffer group 35 is: D24, D21, D22, and D23 arranged sequentially from the first chunk position CK1 to the fourth chunk position CK4.

Referring to FIG. 13C, the shift data DATA_S, stored in the sub-buffer group 35, may be transmitted to the initialized page buffers of the page buffer group 33. Then, the sub-buffers included in the sub-buffer group 35 may be initialized.

By means of the method described above with reference to FIGS. 13A to 13C, the remaining data stored in the page buffer group 33 may be converted into shift data DATA_S on a row basis. When all of data shift operations are completed, the shift data DATA_S stored in the page buffer group 33 may be programmed to the second memory block BLK2. The data stored in the second memory block BLK2 may correspond to the data stored in page PG1 of the second memory block BLK2, for example, as shown in FIG. 11.

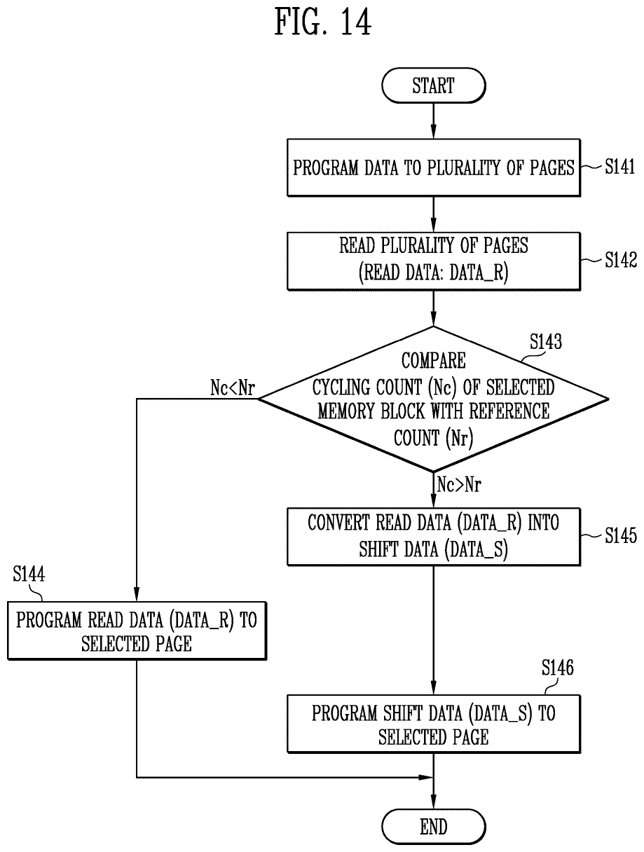

FIG. 14 is a flowchart illustrating a migration operation according to a second embodiment of the present disclosure.

Referring to FIG. 14, in the above-described first embodiment, the step of converting read data into shift data during a migration operation is performed by default. In the second embodiment, the step of converting read data into shift data may be determined depending on the cycling count of the memory block. The migration operation according to the second embodiment will be described in detail below.

When data output from a controller is input, the memory device may program data to a plurality of pages included in a selected memory block at S141. At S141, the memory device may perform a program operation according to a single-level cell (SLC) scheme. For example, at S141, the program operation may be performed in a scheme for storing 1 bit of data in one memory cell.

By the program operation according to the single-level cell (SLC) scheme, the memory cells may be identified as a memory cell in an erase state ER or in a program state Ps. When the threshold voltages of memory cells are divided into the erase state ER and the program state Ps, the program operation according to the single-level cell (SLC) scheme is completed, and thus the program operation may be completed faster than the program operation according to the multi-level cell (MLC) scheme.

Among the multi-level cell (MLC) schemes, a quad-level cell (QLC) scheme is described by way of example. Memory cells programmed according to the quad-level cell (QLC) scheme may be in the erase state ER, or may be programmed to any one of first to fifteenth program states P1 to P15. Therefore, the program operation performed according to the quad-level cell (QLC) scheme requires a longer time than the single-level cell (SLC) scheme. Therefore, the memory device may program data by performing a program operation according to the single-level cell (SLC) scheme earlier than a program operation according to the multi-level cell (MLC) scheme. In the program operation according to the single-level cell (SLC) scheme, 1 bit of data may be stored in one memory cell, and in the program operation according to the quad-level cell (QLC) scheme, 4 or more bits of data may be stored in one memory cell.

When the program operation according to the single-level cell (SLC) scheme is completed, at S142, the memory device may read a plurality of programmed pages from the selected memory block. The read data DATA_R, which is read from the plurality of pages, may be stored in a page buffer group, e.g., page buffer group 33.

When the read data DATA_R is stored in the page buffer group, at S143, the memory device may compare the cycling count Nc of the selected memory block on which the read operation is performed with a reference count Nr. The cycling count Nc may be the number of erase operations and of program operations performed on the memory block. For example, whenever an erase operation and a program operation are performed once on the selected memory block, the cycling count Nc of the selected memory block may be increased by a set number (e.g., 1). The reference count Nr may be a value prestored in the memory device, and may be stored as different values depending on the memory device.

When it is determined at S143 that the cycling count Nc is less than the reference count Nr, the reliability of the selected memory block may be determined to be maintained. In this case, the memory device may skip a data shift operation, and may program the read data to a selected page of another memory block at S144. The program operation at S144 may be performed according to a multi-level cell (MLC) scheme.

When it is determined at S143 that the cycling count Nc is greater than the reference count Nr, the reliability of the selected memory block may be determined to be deteriorated. In this case, at S145, the memory device may perform a data shift operation of converting the read data DATA_R stored in the page buffer group into shift data DATA_S, by shifting at least a portion of the read data DATA_R. For example, the portion of the read data DATA_R may be shifted on a chunk basis, and may then be converted into the shift data DATA_S. The shift data DATA_S may correspond to that shown, for example, in FIG. 10B.

When it is determined at S143 that the cycling count Nc is equal to the reference count Nr, the process may be set to perform S144 or S145 depending on the memory device.

When the read data DATA_R is converted into the shift data DATA_S, at S146, the memory device may program the shift data DATA_S to a selected page included in another memory block. For example, the memory device may select a memory block set in a multi-level cell (MLC) scheme, and may program the shift data DATA_S to a page selected from among pages included in the selected memory block according to the multi-level cell (MLC) scheme. In this way, the data stored in the SLC cells of four pages of a first memory block (e.g., memory block BLK1) may be stored in the MLC cells in a single page of a second memory block (e.g., memory block BLK2).

After performing S146, the memory device may perform an erase operation on the memory block from which the read data DATA_R is read. Because the memory block on which the erase operation is performed is designated as a block having free status (e.g., eligible to store data), it may be selected again during a subsequent program operation according to the single-level cell (SLC) scheme.

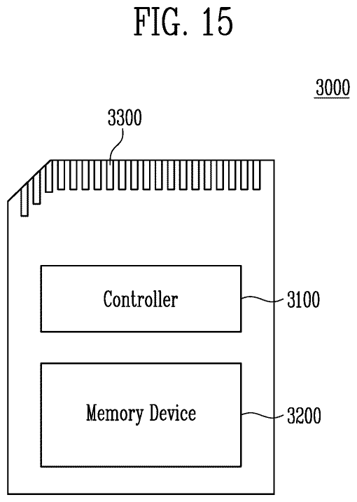

FIG. 15 is a diagram illustrating a memory card system 3000 including a memory device 3200 according to an embodiment of the present disclosure. The memory device 3200 may correspond to the memory device 100 shown in FIG. 1.

Referring to FIG. 15, the memory card system 3000 includes a controller 3100, a memory device 3200, and a connector 3300. The controller 3100 is connected to the memory device 3200. The controller 3100 may access the memory device 3200. For example, the controller 3100 may control a program operation, a read operation, or an erase operation of the memory device 3200 or control background operations of the memory device 3200. The controller 3100 may serve as an interface between the memory device 3200 and a host, e.g., host 300 in FIG. 1. The controller 3100 may run firmware for controlling the memory device 3200. For example, the controller 3100 may include components, such as a random access memory (RAM), a processor, a host interface, a memory interface, and an error correction circuit.

The controller 3100 may communicate with an external device through the connector 3300. The controller 3100 may communicate with an external device (e.g., host 100) based on a specific communication standard. In an embodiment, the controller 3100 may communicate with the external device through at least one of various communication standards such as universal serial bus (USB), multimedia card (MMC), embedded MMC (eMMC), peripheral component interconnection (PCI), PCI-express (PCI-e or PCIe), an advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and nonvolatile memory express (NVMe). In an embodiment, the connector 3300 may be defined by at least one of the above-described various communication standards.

The memory device 3200 may include memory cells, and may be configured in the same manner as the memory device 100 illustrated in FIG. 3. For example, the memory device 3200 may program data to a first memory block according to a single-level cell (SLC) scheme, and may perform a read operation on the first memory block to temporarily store the read data. Then, the memory device 3200 may generate shift data by shifting the read data on a chunk basis, and may program the shift data to a second memory block according to a multi-level cell (MLC) scheme. The memory device 3200 may then erase data stored in the first memory block so that the first memory block has additional space for storing data.

The controller 3100 and the memory device 3200 may be integrated into a single semiconductor device to form a memory card. For example, the controller 3100 and the memory device 3200 may be integrated into a single semiconductor device and may then form a memory card such as a PC card (personal computer memory card international association: PCMCIA), a compact flash card (CF), a smart media card (SM or SMC), a memory stick, a multimedia card (e.g., MMC, RS-MMC, MMCmicro or eMMC), a secure digital (SD) card (e.g., SD, miniSD, microSD, or SDHC), universal flash storage (UFS), or the like.

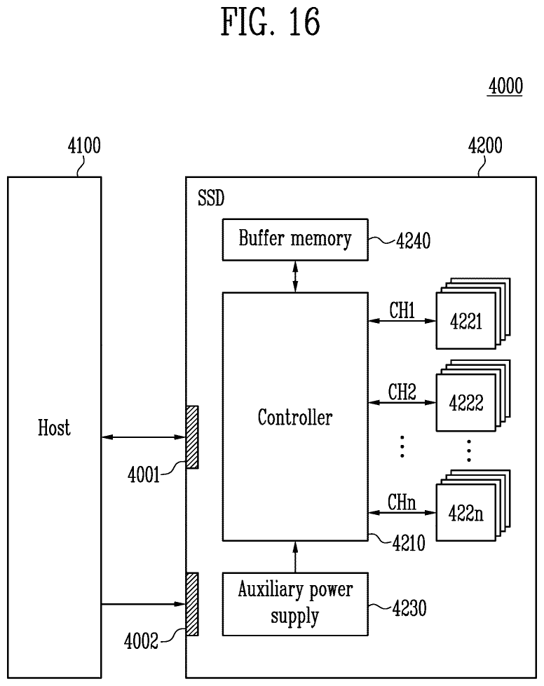

FIG. 16 is a diagram illustrating a solid state drive (SSD) system 4000 including a memory device according to an embodiment of the present disclosure. The memory device may correspond, for example, to the memory device of FIG. 1.

Referring to FIG. 16, the SSD system 4000 may include a host 4100 and an SSD 4200. The SSD 4200 may exchange signals with the host 4100 through a signal connector 4001, and may receive power through a power connector 4002. The SSD 4200 may include a controller 4210, a plurality of memory devices 4221 to 422n, an auxiliary power supply 4230, and a buffer memory 4240.

The controller 4210 may control the plurality of memory devices 4221 to 422n in response to signals received from the host 4100. In an embodiment, the signals may be signals based on the interfaces of the host 4100 and the SSD 4200. For example, the signals may be signals defined by at least one of interfaces such as universal serial bus (USB), multimedia card (MMC), embedded MMC (eMMC), peripheral component interconnection (PCI), PCI-express (PCI-e or PCIe), advanced technology attachment (ATA), serial-ATA (SATA), parallel-ATA (PATA), small computer system interface (SCSI), enhanced small disk interface (ESDI), integrated drive electronics (IDE), Firewire, universal flash storage (UFS), WiFi, Bluetooth, and nonvolatile memory express (NVMe).

Each of the plurality of memory devices 4221 to 422n may include cells in which data can be stored. Each of the plurality of memory devices 4221 to 422n may be configured in the same manner as the memory device 100 illustrated in FIG. 3.

For example, at least one of the plurality of memory devices 4221 to 422n may program data to a first memory block according to a single-level cell (SLC) scheme, and may perform a read operation on the first memory block to temporarily store the read data. Then, at least one of the plurality of memory devices 4221 to 422n may generate shift data by shifting the read data on a chunk basis, and may program the shift data to a second memory block according to a multi-level cell (MLC) scheme. The data stored in the first memory block may then be erased to increase the available space in the first memory block for storing additional data.

The auxiliary power supply 4230 may be connected to the host 4100 through the power connector 4002. The auxiliary power supply 4230 may be supplied with power from the host 4100, and may be charged. The auxiliary power supply 4230 may provide the supply voltage of the SSD 4200 when the supply of power from the host 4100 is not smoothly performed. In an embodiment, the auxiliary power supply 4230 may be located inside the SSD 4200 or located outside the SSD 4200. For example, the auxiliary power supply 4230 may be located on a main board, and may provide auxiliary power to the SSD 4200.

The buffer memory 4240 functions as a buffer memory of the SSD 4200. For example, the buffer memory 4240 may temporarily store data received from the host 4100 or data received from the plurality of memory devices 4221 to 422n or may temporarily store metadata (e.g., mapping tables) of the memory devices 4221 to 422n. The buffer memory 4240 may include volatile memories, such as DRAM, SDRAM, DDR SDRAM, and LPDDR SDRAM, or nonvolatile memories, such as FRAM, ReRAM, STT-MRAM, and PRAM.

According to the present disclosure, an increase in the number of bad blocks attributable to uncorrectable errors may be prevented.

While the embodiments of the present disclosure has been illustrated and described with respect to specific embodiments and drawings, the disclosed embodiments are not intended to be restrictive. Further, it is noted that the embodiments may be achieved in various ways through substitution, change, and modification, as those skilled in the art will recognize in light of the present disclosure, without departing from the spirit and/or scope of the present disclosure and the following claims. Furthermore, the embodiments may be combined to form additional embodiments.

What is claimed is:

1. A memory device, comprising:
a first memory block and a second memory block;
a peripheral circuit coupled to the first memory block and the second memory block; and
a control circuit configured to control the peripheral circuit to program first data to the first memory block according to a single-level cell (SLC) scheme, generate second data by converting data read from the first memory block on a chunk basis, and program the second data to the second memory block according to a multi-level cell (MLC) scheme, wherein each chunk corresponds to bits stored in a plurality of memory cells.

2. The memory device according to claim 1, wherein the peripheral circuit is configured to program the first data to a plurality of pages included in the first memory block under control of the control circuit.

3. The memory device according to claim 2, wherein the peripheral circuit is configured to:
read the first data programmed to the first memory block under control of the control circuit, and
generate the second data by converting data, corresponding to at least one of the plurality of pages, in the first data, into units of a plurality of chunks.

4. The memory device according to claim 1, wherein the peripheral circuit is configured to, after the first data is converted into the second data, program the second data to a page included in the second memory block under control of the control circuit.

5. A memory device, comprising:
a first memory block and a second memory block connected to bit lines;
page buffers configured to change voltages of the bit lines based on original data during a program operation on the first memory block, and store read data, read from the first memory block, during a read operation on the first memory block;
sub-buffers configured to receive the read data from the page buffers, generate shift data by changing column addresses of a portion of the read data, the portion of read data corresponding to a plurality of bits, and transmit the shift data to the page buffers; and
a control circuit configured to control the page buffers, the sub-buffers, and a voltage generator to program the original data having n bits to each of memory cells of the first memory block, and program the shift data having N bits more than the n bits to each of memory cells of the second memory block, wherein n is greater than 0 and N is greater than 0,
wherein the control circuit is configured to, when the read data is converted into the shift data, control the page buffers and the sub-buffers so that the plurality of bits of the portion of the read data is shifted from a first set of columns to a second set of columns in a predetermined direction.

6. The memory device according to claim 5, wherein n and N are natural numbers.

7. The memory device according to claim 5, wherein the control circuit is configured to control the sub-buffers so that, among the plurality of bits of the read data, data corresponding to at least one of pages of the first memory block is shifted from the first set of columns to the second set of columns in the predetermined direction.

8. The memory device according to claim 7, wherein the control circuit is configured to control the sub-buffers so that, when the data is converted on a chunk basis, data corresponding to different pages are converted into chunks for which different column addresses are designated.

9. A memory device, comprising:
a first memory block and a second memory block;
a peripheral circuit configured to program first data to the first memory block, read the first memory block, and program the first data or second data, obtained by converting at least one chunk of the first data, to the second memory block, the at least one chunk including a plurality of bits; and
a control circuit configured to control the peripheral circuit to program the first data to the first memory block according to a single-level cell (SLC) scheme, convert the first data into the second data, and program the first data or the second data to the second memory block according to a multi-level cell (MLC) scheme depending on a cycling count of the first memory block.

10. The memory device according to claim 9, wherein the control circuit is configured to control the peripheral circuit to program the first data to the second memory block when the cycling count is less than a reference count.

11. The memory device according to claim 10, wherein the control circuit is configured to control the peripheral circuit to skip an operation of converting the first data into the second data when the cycling count is less than the reference count.

12. The memory device according to claim 9, wherein the control circuit is configured to control the peripheral circuit to program the second data to the second memory block when the cycling count is greater than a reference count.

13. A method of operating a memory device, comprising:
storing read data, read from a first memory block, in page buffers divided into chunks that are units of error correction;
transmitting the read data, stored in the page buffers, to sub-buffers;
converting the read data stored in the sub-buffers into shift data by shifting the read data, transmitted to the sub-buffers, to sub-buffers corresponding to different chunks;
transmitting the shift data, stored in the sub-buffers, to the page buffers; and
programming the shift data, transmitted to the page buffers, to a second memory block, wherein each of the different chunks includes a plurality of bits.

14. The method according to claim 13, wherein the converting of the read data into the shift data comprises:
transmitting data, stored in sub-buffers corresponding to a first chunk, among the sub-buffers, to sub-buffers corresponding to a second chunk;
transmitting data, stored in the sub-buffers corresponding to the second chunk, among the sub-buffers, to sub-buffers corresponding to a third chunk; and
transmitting data, stored in the sub-buffers corresponding to the third chunk, among the sub-buffers, to sub-buffers corresponding to the first chunk.

15. A method of operating a memory device, comprising:
storing read data, read from a first memory block, in page buffers divided into chunks that are units of error correction;
comparing a cycling count of the first memory block with a reference count;
programming the read data to a second memory block when the cycling count is less than the reference count; and
generating shift data by converting the read data into units of chunks, and programming the shift data to the second memory block when the cycling count is greater than the reference count.

16. The method according to claim 15, wherein a program operation performed on the first memory block is performed according to a scheme in which 1 bit of data is stored in one memory cell.

17. The method according to claim 15, wherein a program operation performed on the second memory block is performed according to a scheme in which at least 2 bits of data are stored in one memory cell.
